(19) United States
(12) Patent Application Publication
(10) Pub. No.: US 2026/0044434 A1
(43) Pub. Date: Feb. 12, 2026

(54) SYSTEMS AND METHODS FOR AUTOMATICALLY TESTING CHANGES TO A SOFTWARE APPLICATION USING MACHINE LEARNING

(71) Applicant: Walmart Apollo, LLC, Bentonville, AR (US)

(72) Inventors: Yoseph Reuveni, Orange, NJ (US); Pankaj Vilas Takawale, Princeton, NJ (US); Tomer Lancewicki, Parkland, FL (US)

(21) Appl. No.: 18/795,527

(22) Filed: Aug. 6, 2024

(51) Int. Cl. G06F 11/36

(52) U.S. Cl. CPC G06F 11/3668

(57) ABSTRACT

Systems and methods for automatically testing changes to a software application using machine learning are disclosed. In some embodiments, a disclosed method includes: obtaining, from a computing device, a request for a proposed change to an application; generating at least one baseline instance running an existing version of the application before the proposed change; generating a candidate instance running a new version of the application based on the proposed change; performing an analysis on the at least one baseline instance and the candidate instance to determine, using at least one machine learning model, whether an anomaly exists in the candidate instance; generating a report for the proposed change based on the analysis; and transmitting the report to the computing device.

### TECHNICAL FIELD

This application relates generally to software development and optimization and, more particularly, to systems and methods for automatically testing changes to a software application using machine learning before deployment.

### BACKGROUND

In the rapidly evolving field of software development, ensuring the robustness and efficiency of application production systems is critical. In the absence of effective mechanisms, application developers or engineers are responsible for manually testing any proposed change to a software application, to avoid performance degradation that will impact users.

In some examples, the developers may roll out a new feature of an application to a subset of users as a trial deployment before rolling out the new feature fully. But if there is any issue with the new feature (e.g., having a performance degradation or showing an increased error rate), requests for that trial deployment are potentially sacrificed until the issue is resolved or rolled back. This means a fraction of user requests will fail.

Some approaches tried to test production changes at an earlier stage in the development process (e.g. based on left shift testing). But these existing systems and methods for application testing require lots of human efforts and manual processes, do not follow a production like traffic pattern, and/or cannot avoid impacts to end users.

### SUMMARY

The embodiments described herein are directed to systems and methods for automatically testing changes to a software application using machine learning.

In various embodiments, a system including a non-transitory memory configured to store instructions thereon and at least one processor is disclosed. The at least one processor is operatively coupled to the non-transitory memory and configured to read the instructions to: obtain, from a computing device, a request for a proposed change to an application; generate at least one baseline instance running an existing version of the application before the proposed change; generate a candidate instance running a new version of the application based on the proposed change; perform an analysis on the at least one baseline instance and the candidate instance to determine, using at least one machine learning model, whether an anomaly exists in the candidate instance; generate a report for the proposed change based on the analysis; and transmit the report to the computing device.

In various embodiments, a computer-implemented method is disclosed. The computer-implemented method includes: obtaining, from a computing device, a request for a proposed change to an application; generating at least one baseline instance running an existing version of the application before the proposed change; generating a candidate instance running a new version of the application based on the proposed change; performing an analysis on the at least one baseline instance and the candidate instance to determine, using at least one machine learning model, whether an anomaly exists in the candidate instance; generating a report for the proposed change based on the analysis; and transmitting the report to the computing device.

In various embodiments, a non-transitory computer readable medium having instructions stored thereon is disclosed. The instructions, when executed by at least one processor, cause at least one device to perform operations including: obtaining, from a computing device, a request for a proposed change to an application; generating at least one baseline instance running an existing version of the application before the proposed change; generating a candidate instance running a new version of the application based on the proposed change; performing an analysis on the at least one baseline instance and the candidate instance to determine, using at least one machine learning model, whether an anomaly exists in the candidate instance; generating a report for the proposed change based on the analysis; and transmitting the report to the computing device.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured for automatically testing changes to a software application using machine learning, in accordance with some embodiments of the present teaching;

FIG. 2 is a block diagram of an application test computing device, in accordance with some embodiments of the present teaching;

FIG. 3 is a block diagram illustrating various portions of a system for automatically testing changes to a software application using machine learning, in accordance with some embodiments of the present teaching;

FIG. 4 illustrates an exemplary process for automatically testing changes to a software application, in accordance with some embodiments of the present teaching;

FIG. 5 illustrates a detailed process for automatically testing changes to a software application in an isolated test environment, in accordance with some embodiments of the present teaching;

FIG. 6 illustrates an exemplary process for traffic selection and anomaly persistency determination during application testing, in accordance with some embodiments of the present teaching;

FIG. 7 illustrates an exemplary process for anomaly insight generation during application testing, in accordance with some embodiments of the present teaching;

FIG. 8 shows a flowchart illustrating an exemplary method for automatically testing changes to a software application using machine learning, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

To ensure the robustness and efficiency of an application system, it is critical to test production changes with production traffic without impacting end user in any manner. One objective of various embodiments in the present teaching is to provide an automatic testing framework for both functional testing and non-functional testing in production environments using machine learning. A disclosed method is designed to be risk-free and cost-effective and aims to exploit and early identify service degradation. In some embodiments, a disclosed system can capture incoming production traffic and direct it to a new and parallel service, where changes to a software application can be reviewed for drifts, patterns, logical errors, and performance degradation without any impact to the users.

In some embodiments, the system takes a shift left approach for testing a new candidate version of application, during a pull request flow and deployment flow. When an engineer creates a pull request from feature branch or deploys the new candidate version to production environment, the system would create an isolated or shadow environment in the same namespace of the application on the production clusters, to test both (1) application baseline instances hosting the existing production version of the application, and (2) an application candidate instance hosting the new candidate version of the application, to identify and resolve any detected anomaly in the new candidate version, without impacting the users' experience (e.g. in terms of latency or service availability) of the application.

In some embodiments, the system utilizes a reinforcement learning (RL) model specifically tailored to dynamically adapt and optimize testing strategies. While several machine learning models could be applied, the unique requirements of production-grade testing in functional (e.g. add-to-cart, get items, remove from cart, etc.) and non-functional (e.g. latency, load, logging, timeout rate, etc.) domains suggest using deep reinforcement learning (DRL) models. In some embodiments, the system uses Deep Q-Networks (DQN) and Proximal Policy Optimization (PPO), due to their abilities to handle complex state spaces and learn optimal actions from high-dimensional sensory input like real-world testing environments.

In some use cases, an entity, e.g. a retailer, provides an application via an application programming interface (API) or a website to users. While a substantive portion of application incidents result from changes to the application, the disclosed system can generate and provide insights on how the website would perform given the changes in production, without any impact to the users (including online shoppers, vendors, associates, etc.), which paves the way forward for a more robust production environment. In some embodiments, the disclosed method can support hypertext transfer protocol (HTTP) and any query language over HTTP protocols, and can work in addition to stress testing, resiliency testing, etc.

In some embodiments, the system can leverage the shift left methodology and automatically provide its insights to the developer as early as the developer is opening a pull request with code or runtime configuration change. This empowers engineers to assess the direct and in-direct impact of their code changes before merging those into the main trunk of application. By providing those insights early in the development process, the system reduces or eliminates efforts wasted if such anomalies were found later in the software development lifecycle process such as integration testing or production release cycle that would cause customer impact.

Furthermore, in the following, various embodiments are described with respect to systems and methods for automatically testing changes to a software application using machine learning are disclosed. In some embodiments, a disclosed method includes: obtaining, from a computing device, a request for a proposed change to an application; generating at least one baseline instance running an existing version of the application before the proposed change; generating a candidate instance running a new version of the application based on the proposed change; performing an analysis on the at least one baseline instance and the candidate instance to determine, using at least one machine learning model, whether an anomaly exists in the candidate instance; generating a report for the proposed change based on the analysis; and transmitting the report to the computing device.

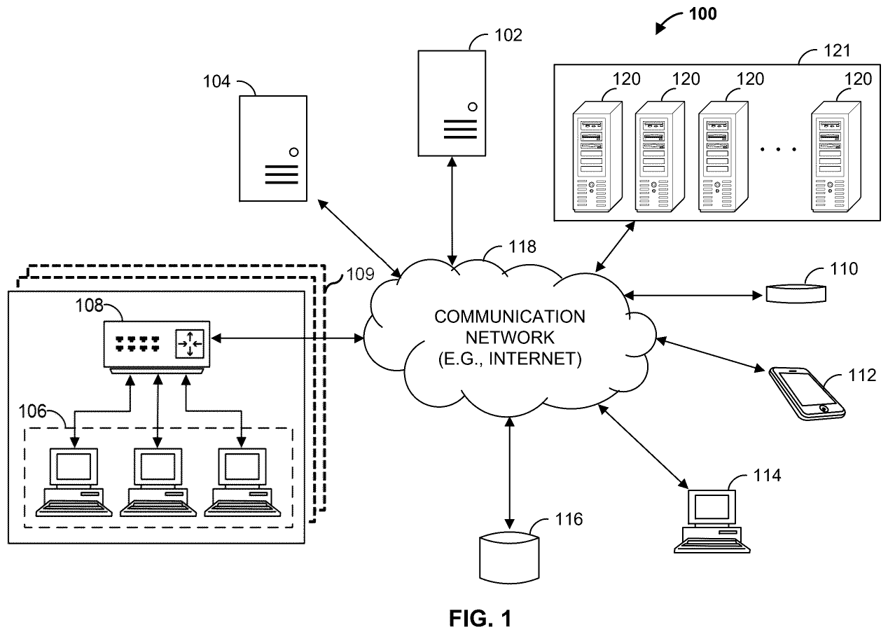

Turning to the drawings, FIG. 1 is a network environment 100 configured for automatically testing changes to a software application using machine learning, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, an application test computing device 102, a server 104 (e.g., a web server or an application server), a cloud-based engine 121 including one or more processing devices 120, workstation(s) 106, a database 116, and one or more user computing devices 110, 112, 114 operatively coupled over the network 118. The application test computing device 102, the server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the application test computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the application test computing device 102.

In some examples, each of the multiple user computing devices 110, 112, 114 can be a cellular phone, a smart phone, a tablet, a personal assistant device, a voice assistant device, a digital assistant, a laptop, a computer, a laser-based code scanner, or any other suitable device. In some examples, the server 104 hosts one or more websites or apps providing one or more products or services. In some examples, the application test computing device 102, the processing devices 120, and/or the server 104 are operated by a corporation, e.g. a big retailer, and the multiple user computing devices 110, 112, 114 are operated by customers, advertisers, associates or managers of the corporation. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at one or more departments 109 of a corporation. In some examples, the departments 109 correspond to different services, product categories, corporate functions, retail departments, stores, channels and/or platforms of a retailer. In some examples, different departments 109 may execute different applications that are integrated using clusters and topics via a data service platform.

The workstation(s) 106 can communicate with the application test computing device 102 over the communication network 118. The workstation(s) 106 may send data to, and receive data from, the application test computing device 102. For example, the workstation(s) 106 may transmit data identifying transactions, inventory or supply chain data at the one or more departments 109 to the application test computing device 102. The workstation(s) 106 may also transmit other data related to the one or more departments 109 to the application test computing device 102.

Although FIG. 1 illustrates three user computing devices 110, 112, 114, the network environment 100 can include any number of user computing devices 110, 112, 114. Similarly, the network environment 100 can include any number of the application test computing devices 102, the processing devices 120, the workstations 106, the departments 109, the servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the departments 109 over the communication network 118. For example, one of the multiple user computing devices 110, 112, 114 may be operable to view, access, and interact with a website, such as a retailer's website, hosted by a server in an e-commerce department 109. The server may transmit user session data related to a customer's activity (e.g., interactions) on the website. For example, a customer may operate one of the user computing devices 110, 112, 114 to initiate a web browser that is directed to the website. The customer may, via the web browser, search for items, view item advertisements for items displayed on the website, and click on item advertisements and/or items in the search result, for example. The website may capture these activities as user session data, and transmit the user session data to the application test computing device 102 over the communication network 118. The website may also allow the operator to add one or more of the items to an online shopping cart, and allow the customer to perform a “checkout” of the shopping cart to purchase the items. In some examples, the application test computing device 102 obtains metadata regarding purchase data and user interaction data exchanged between the departments 109.

In some embodiments, an engineer (or a manager or an associate) of a corporation (e.g. a retailer) may operate one of the user computing devices 110, 112, 114 to access an application programming interface (API) hosted by the server 104. The engineer may, via the API, submits a pull request to propose a change or update to the application or website associated with the retailer. The engineer may also submit a deployment request to deploy a proposed change to the application, upon reviewing any feedback data based on a test performed on the proposed change. The engineer may perform these actions during a development stage or a production stage of the application. The API may capture these activities as user session data or as they are, and transmit these activities to the application test computing device 102 over the communication network 118.

In some examples, the server 104 transmits to the application test computing device 102 a pull request for a proposed change to an application. In some examples, the application test computing device 102 may execute one or more models (e.g., programs or algorithms), such as a machine learning model, deep learning model, statistical model, etc., to test the proposed change and generate feedback data. The feedback data may be generated based on an analysis both on at least one baseline instance running an existing version of the application before the proposed change, and on a candidate instance running a new version of the application based on the proposed change. The application test computing device 102 may perform the analysis in an isolated test environment to determine, using at least one machine learning model, whether an anomaly exists in the candidate instance. The application test computing device 102 may then generate a report for the proposed change based on the analysis, and transmit the report as the feedback data to the server 104.

In some examples, the server 104 transmits to the application test computing device 102 a deployment request seeking a deployment of one or more changes to the application, wherein each of these changes has been tested and approved by the application test computing device 102. In some examples, the application test computing device 102 may execute one or more models (e.g., programs or algorithms), such as a machine learning model, deep learning model, statistical model, etc., to re-perform the analysis on the at least one baseline instance and the candidate instance during a deployment flow involving all of the one or more approved changes in the isolated test environment, before or while deploying the one or more approved changes into the application. The application test computing device 102 may keep monitoring the deployed changes and transmit monitoring data to the server 104.

In some embodiments, the application test computing device 102 is further operable to communicate with the database 116 over the communication network 118. For example, the application test computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the application test computing device 102, in some examples, the database 116 can be a local storage device, such as a hard drive, a non-volatile memory, or a USB stick. For example, the application test computing device 102 may store user request and instruction data received from the server 104 in the database 116. The application test computing device 102 may receive department related data from the one or more departments 109 and store them in the database 116. The application test computing device 102 may also receive from an e-commerce department 109 user session data identifying events associated with browsing sessions, and may store the user session data in the database 116.

In some examples, the application test computing device 102 generates and/or updates different models (e.g., machine learning models, deep learning models, statistical models, algorithms, etc.) for automatically testing changes to a software application using machine learning. The application test computing device 102 may generate training data for the models based on data including but not limited to: historical application data, historical application health metric data, health related feature data, historical or labelled anomaly data, and anomaly insight data. The application test computing device 102 trains the models based on their corresponding training data, and stores the models in a database, such as in the database 116 (e.g., a cloud storage). The models, when executed by the application test computing device 102, allow the application test computing device 102 to generate test feedback data and application monitoring data.

In some examples, the application test computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the application test computing device 102 may generate test feedback data and application monitoring dat.

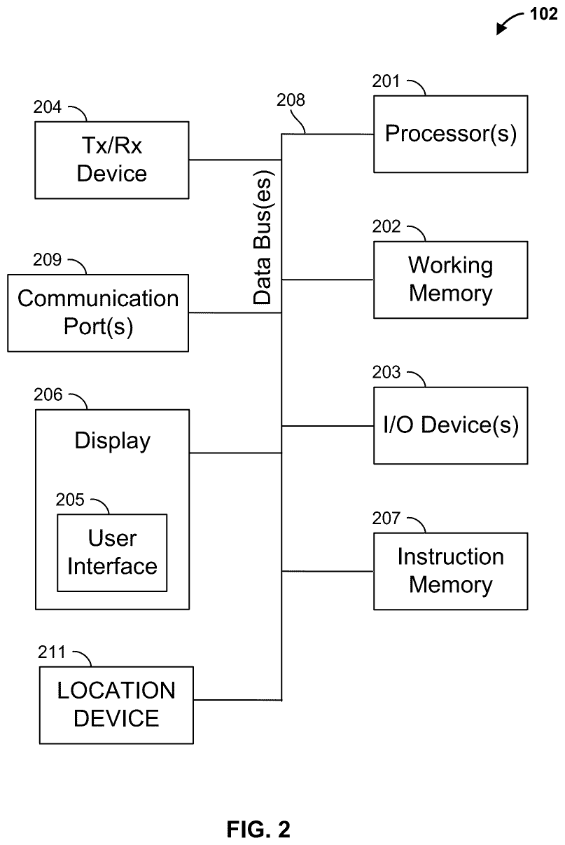

FIG. 2 illustrates a block diagram of an application test computing device, e.g. the application test computing device 102 of FIG. 1, in accordance with some embodiments of the present teaching. In some embodiments, each of the application test computing device 102, the server 104, the workstation(s) 106, the multiple user computing devices 110, 112, 114, and the one or more processing devices 120 in FIG. 1 may include the features shown in FIG. 2. Although FIG. 2 is described with respect to certain components shown therein, it will be appreciated that the elements of the application test computing device 102 can be combined, omitted, and/or replicated. In addition, it will be appreciated that additional elements other than those illustrated in FIG. 2 can be added to the application test computing device 102.

As shown in FIG. 2, the application test computing device 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the application test computing device 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the application test computing device 102 can include a single memory unit configured to operate as both instruction memory and working memory. Further, although embodiments are discussed herein including non-volatile memory, it will be appreciated that the application test computing device 102 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the application test computing device 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the application test computing device 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the application test computing device 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the application test computing device 102 and/or the server 104. For example, the user interface 205 can be a user interface for an application of a network environment operator that allows a customer to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the application test computing device 102 may determine a local geographical area (e.g., town, city, state, etc.) of its position.

In some embodiments, the application test computing device 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

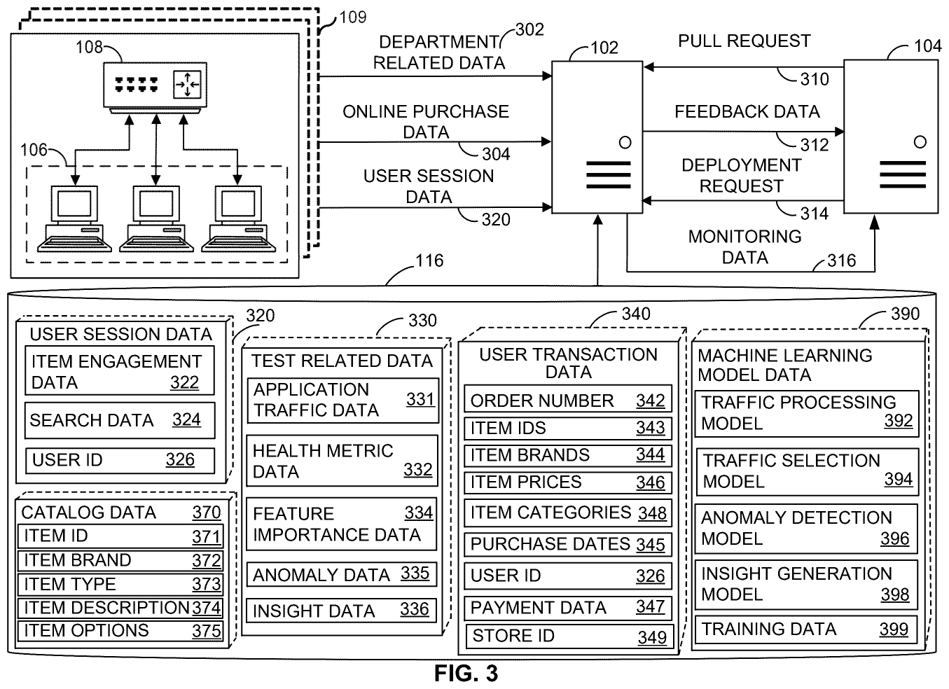

FIG. 3 is a block diagram illustrating various portions of a system for automatically testing changes to a software application using machine learning, e.g. the system shown in the network environment 100 of FIG. 1, in accordance with some embodiments of the present teaching. As indicated in FIG. 3, the application test computing device 102 may receive user session data 320 from the departments 109 (e.g. an e-commerce department 109), and store the user session data 320 in the database 116. The user session data 320 may identify, for each user (e.g., customer, engineer or manager), data related to that user's browsing session, such as when browsing a retailer's webpage or API.

In some examples, the user session data 320 may include item engagement data 322, search data 324, and user ID 326 (e.g., a customer ID, manager ID, retailer website login ID, a cookie ID, etc.). The item engagement data 322 may include one or more of a session ID (i.e., a website browsing session identifier), item clicks identifying items which a user clicked (e.g., images of items for purchase, keywords to filter reviews for an item), items added-to-cart identifying items added to the user's online shopping cart, advertisements viewed identifying advertisements the user viewed during the browsing session, and advertisements clicked identifying advertisements the user clicked on. The search data 324 may identify one or more searches conducted by a user during a browsing session (e.g., a current browsing session).

The application test computing device 102 may also receive online purchase data 304 from the e-commerce department 109, which identifies and characterizes one or more online purchases, such as purchases made by the user and other users via a retailer's website hosted by the e-commerce department 109. The application test computing device 102 may also receive department related data 302 from the one or more departments 109, which identifies and characterizes transactions, inventory and other retail related data in those departments 109.

The department related data 302 and the online purchase data 304 may be parsed to generate user transaction data 340. The application test computing device 102 may obtain metadata regarding the user transaction data 340 exchanged among sub-systems of the system. In this example, the user transaction data 340 may include, for each purchase, one or more of: an order number 342 identifying a purchase order, item IDs 343 identifying one or more items purchased in the purchase order, item brands 344 identifying a brand for each item purchased, item prices 346 identifying the price of each item purchased, item categories 348 identifying a product type (or category) of each item purchased, purchase dates 345 identifying the purchase dates of the purchase orders, a user ID 326 for the user making the corresponding purchase, payment data 347 indicating payment methods and related information (e.g. emails associated with payment) for corresponding online orders, and store ID 349 for the corresponding in-store purchase, or for the pickup store or shipping-from store associated with the corresponding online purchase.

In some embodiments, the database 116 may further store catalog data 370, which may identify one or more attributes of a plurality of items, such as a portion of or all items a retailer carries in stores and/or at e-commerce platforms. The catalog data 370 may identify, for each of the plurality of items, an item ID 371 (e.g., an SKU number), item brand 372, item type 373 (e.g., grocery item such as milk, clothing item), item description 374 (e.g., a description of the product including product features, such as ingredients, benefits, use or consumption instructions, or any other suitable description), and item options 375 (e.g., item colors, sizes, flavors, etc.).

In some embodiments, the database 116 may further store test related data 330, which may identify related data for testing any change or update to an application or production, such as e-commerce application, in-store application, supply chain application, search application, advertisement application, etc. of a retailer network. The test related data 330 may identify: application traffic data 331 indicating traffic data and characteristics of the application, health metric data 332 indicating metrics of the application health, feature importance data 334 indicating importance of different features to the application health, anomaly data 335 indicating data related to possible anomalies, and insight data 336 indicating insights (e.g. root causes, reasons, impact factors) of possible anomalies.

The database 116 may also store machine learning model data 390 identifying and characterizing one or more models and related data for automatically testing changes to a software application using machine learning. For example, the machine learning model data 390 may include: a traffic processing model 392, a traffic selection model 394, an anomaly detection model 396, an insight generation model 398, and training data 399. In various embodiments, the machine learning model data 390 includes any number of the traffic processing models 392, the traffic selection models 394, the anomaly detection models 396 and the insight generation models 398.

The traffic processing model 392 in this example can be used to collect and process production traffic of an application to be tested for a proposed change. The processing may include but not limited to: traffic sensitization, traffic analysis, pattern matching, endpoint detection, data drift detection, contract drift detection, traffic normalization, etc. The traffic processing model 392 may be a machine learning model developed based on diverse datasets.

The traffic selection model 394 in this example can be used to select a subset of production traffic for testing the proposed change. For example, the system can use the traffic selection model 394 to sample a representative traffic subset of call requests by choosing a subset of sessions subject to a minimum number of call request samples per request type. Each session includes a sequence of call requests, each of which calls to a functional endpoint of the application. The call requests in the plurality of sessions belong to a plurality of request types.

The anomaly detection model 396 can be used to determine whether an anomaly exists in an candidate instance. In some examples, the system can send the selected traffic (e.g. the sampled representative traffic subset) in an isolated environment to at least one baseline instance running an existing version of the application before the proposed change, and to a candidate instance running a new version of the application based on the proposed change. After receiving responses from the at least one baseline instance and the candidate instance, the system can compare the responses from the at least one baseline instance and the candidate instance to determine at least one difference in the responses, and determine whether the at least one difference represents an anomaly due to the proposed change, using the anomaly detection model 396. In some examples, the anomaly detection model 396 can also be used to determine whether a detected anomaly is temporary or persistent based on one or more retries of replaying the selected traffic in the isolated environment against both the at least one baseline instance and the candidate instance.

The insight generation model 398 in this example can be used to generate or determine insight data indicating one or more factors causing the anomaly, in accordance with a determination that the anomaly is persistent. In some examples, the system can generate a report including: the anomaly, the insight data, and a summary of the analysis, and transmit the report as feedback data of the pull request.

In some embodiments, one or more of the traffic processing model 392, the traffic selection model 394, the anomaly detection model 396 and the insight generation model 398 can be implemented as a machine learning model. The training data 399 may include data utilized for training one or more of the traffic processing model 392, the traffic selection model 394, the anomaly detection model 396 and the insight generation model 398. In some examples, the training data 399 may be formed based on: application data, application health metric data, health related feature data, labelled anomaly data, and/or anomaly insight data, obtained from either real data or synthetic data.

In some examples, the application test computing device 102 receives a pull request 310 from the server 104. The pull request 310 may seek to test a proposed change to an application. In some examples, the pull request 310 is submitted by an associate or an engineer of a corporation, or triggered by a detection of the proposed change by monitoring the application at the application test computing device 102. The feedback data 312 is generated and provided to the associate or engineer based on an analysis in an isolated test environment, without impacting the users' experience with the application in production. In some embodiments, the application test computing device 102 may use the traffic processing model 392 to process the production traffic of the application, and use the traffic selection model 394 to select a subset of the processed production traffic. Then, the application test computing device 102 can send the selected traffic in the isolated environment to at least one baseline instance running an existing version of the application before the proposed change, and to a candidate instance running a new version of the application based on the proposed change, to determine whether an anomaly exists in the candidate instance, and generate the feedback data 312 based on the analysis. In response to the pull request 310, the application test computing device 102 transmits the feedback data 312 to the server 104.

In some examples, the application test computing device 102 receives a deployment request 314 from the server 104. The recover request 314 may seek a deployment of one or more changes to the application, wherein each of these changes has been tested and approved by the application test computing device 102, e.g. upon a respective pull request. In some examples, the application test computing device 102 may the same models when generating the feedback data 312, to re-perform the analysis on the at least one baseline instance and the candidate instance during a deployment flow involving all of the one or more approved changes in the isolated test environment, before or while deploying the one or more approved changes into the application. The application test computing device 102 may keep monitoring the deployed changes and transmit the monitoring data 316 to the server 104.

In some embodiments, the application test computing device 102 may assign one or more of the above described operations to a different processing unit or virtual machine hosted by one or more processing devices 120. Further, the application test computing device 102 may obtain the outputs of the these assigned operations from the processing units, and generate the feedback data 312 and/or the monitoring data 316 based on the outputs.

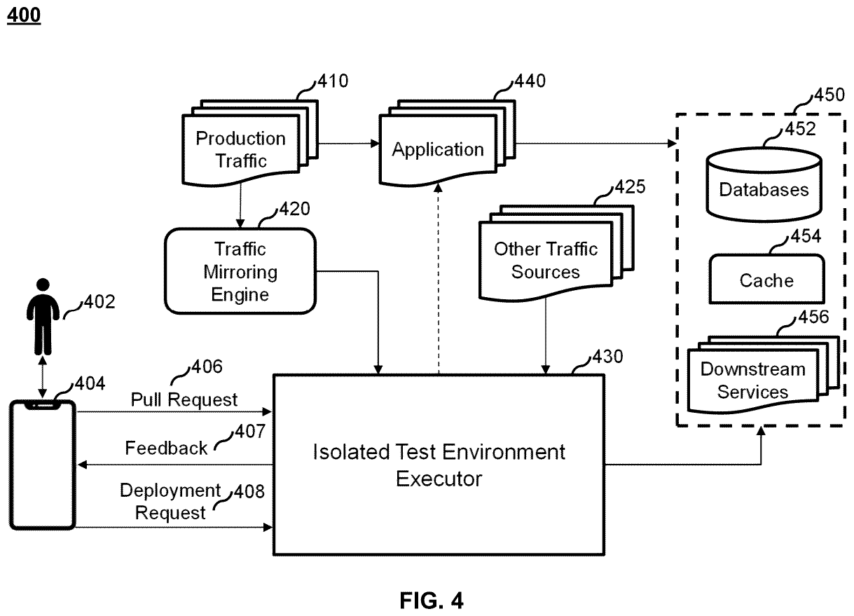

FIG. 4 illustrates an exemplary process 400 for automatically testing changes to a software application, in accordance with some embodiments of the present teaching. In some embodiments, the process 400 can be carried out by one or more computing devices, such as the application test computing device 102, the server 104, the cloud-based engine 121 and/or one of the user computing devices 110, 112, 114 of FIG. 1.

As shown in FIG. 4, the process 400 starts from a user 402 sending a pull request 406, via a user device 404, to an isolated test environment executor 430 for testing a proposed change to an application. In some embodiments, the user 402 is an engineer or developer of the application. In some embodiments, the application is at least one of: a software application associated with an individual or an entity, a software application running on a data service platform, or a software application running on an online platform. In some embodiments, the user device 404 may be implemented as any one of the user computing devices 110, 112, 114 of FIG. 1; the isolated test environment executor 430 may be implemented in the application test computing device 102, the server 104, or the cloud-based engine 121.

In some embodiments, when the application is onboarding, the isolated test environment executor 430 creates a shadow environment or isolated test environment for the application that is running in a production environment, within the application's namespace on the same production cluster. In some embodiments, the isolated test environment is created by identifying and isolating traffic flows that are capable of impacting users of the application.

As shown in FIG. 4, a traffic mirroring engine 420 can analyze the production traffic 410 of the application in the production environment, and generate mirrored traffic in the isolated environment based on the production traffic in the production environment. In some embodiments, the mirrored traffic in the isolated environment accurately mirrors the production traffic while ensuring zero customer impact. This is achieved by intelligently identifying and isolating traffic flows that could cause side effects or impacts to the users. For example, by permitting only safe operations and filtering out non-idempotent implementations, the system safeguards the production environment during testing, allowing for seamless evaluations of new versions without affecting end-users.

In some embodiments, upon receiving the pull request 406 or detecting a new change deployment of the application, the isolated test environment executor 430 sets up or generates at least one baseline instance running an existing version of the application before the proposed change, and simultaneously launches a candidate instance running a new version of the application based on the proposed change, both in the isolated environment. The isolated test environment executor 430 then performs an analysis on the at least one baseline instance and the candidate instance in the isolated environment to determine, using at least one machine learning model, whether an anomaly exists in the candidate instance.

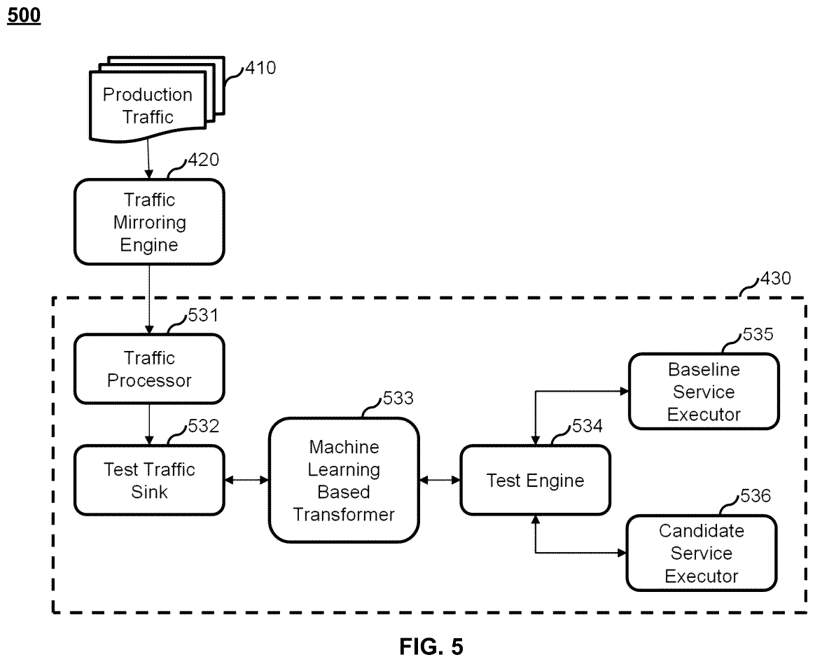

A detailed structure of the isolated test environment executor 430 is shown in FIG. 5. FIG. 5 illustrates a detailed process 500 for automatically testing changes to a software application in an isolated test environment, in accordance with some embodiments of the present teaching. In some embodiments, the process 500 can be carried out by one or more computing devices, such as the application test computing device 102, the server 104, and/or the cloud-based engine 121 of FIG. 1.

As shown in FIG. 5, the isolated test environment executor 430 in this example includes a traffic processor 531, a test traffic sink 532, a machine learning based transformer 533, a test engine 534, a baseline service executor 535 and a candidate service executor 536. In some embodiments, the traffic processor 531 collects mirrored traffic data from the traffic mirroring engine 420 and processes the mirrored traffic data based on timestamp synchronization, null value handling and text normalization, to generate normalized traffic data. In some embodiments, the processing performed by the traffic processor 531 includes at least one of: traffic sensitization, traffic analysis, pattern matching, endpoint detection, data drift detection, contract drift detection, traffic normalization, etc.

In some embodiments, the test traffic sink 532 is responsible for capturing and storing a portion of the mirrored production traffic (e.g. generated and processed by the traffic processor 531) in a buffer, e.g. an in-memory capacity bounded ring buffer, in the isolated test environment. The traffic mirroring process in the system adopts a fire-and-forget style, which means that the responses generated for the mirrored traffic in the test traffic sink 532 are disregarded, ensuring that any issues with the test traffic sink 532, such as unavailability, crashes, or slowdowns, will not affect the production traffic. In some embodiments, the test traffic sink 532 boasts advanced capabilities in detecting APIs with parameters using a cardinality, pattern matching and heuristics-based algorithms. In addition, the test traffic sink 532 can identify traffic by parsing protocol headers and body, ensuring that all relevant traffic is appropriately captured and analyzed.

In some embodiments, the machine learning based transformer 533 selects a subset of traffic from the mirrored traffic stored by the test traffic sink 532. In some examples, the machine learning based transformer 533 determines a plurality of sessions in the mirrored traffic. Each session includes a sequence of call requests, each of which calls to a functional endpoint of the application (e.g. get cart, get item, get price, add to cart, checkout, etc. for an e-commerce application). The call requests in the plurality of sessions belong to a plurality of request types. In some embodiments, the machine learning based transformer 533 samples the call requests in the plurality of sessions to select the subset of traffic subject to a minimum number of request samples per request type. In some embodiments, the traffic selection performed by the machine learning based transformer 533 uplifts low frequency endpoints or sessions or request types, while maintaining a balance or ratio between random samples and anomaly samples (or outlier samples) for each endpoint (or each session or each request type). For example, the machine learning based transformer 533 may select 70% random samples and 30% anomaly samples for each endpoint in the sampled subset of traffic, following its own unique distribution.

The test engine 534 in this example can replay the subset of traffic in the isolated environment against both the at least one baseline instance and the candidate instance, and determine whether an anomaly exists in the candidate instance based on the replaying.

In some embodiments, the test engine 534 sends the same set of sampled traffic to the baseline service executor 535 to execute the at least one baseline instance and to the candidate service executor 536 to execute the candidate instance, and receives responses from the baseline service executor 535 and the candidate service executor 536, respectively. In some examples, the test engine 534 compares the responses from the baseline service executor 535 and the candidate service executor 536 to determine at least one difference in the responses, and determines whether the at least one difference represents an anomaly due to the proposed change, e.g. using a machine learning model.

In some embodiments, the at least one baseline instance comprises two baseline instances, which enables the test engine 534 to detect and filter out noise. For example, to detect an logical error, the test engine 534 sends the same set of sampled traffic to the baseline service executor 535 to execute the two baseline instances and to the candidate service executor 536 to execute the candidate instance, and receives responses from the baseline service executor 535 and the candidate service executor 536, respectively. In some examples, the test engine 534 compares the responses from the two baseline instances to identify noise, e.g. server-timestamp response headers. By filtering out such noise from all responses of the two baseline instances and the candidate instance, the test engine 534 can compare the filtered responses to accurately pinpoint genuine differences in the responses, and determine whether any difference in the filtered responses represents an anomaly due to the proposed change, e.g. using a machine learning model.

In some embodiments, based on responses from a primary baseline instance and the candidate instance, the test engine 534 can compute a raw difference. Based on responses from the primary baseline instance and a secondary baseline instance, the test engine 534 can compute a non-deterministic noise. Based on the raw difference and the non-deterministic noise, the test engine 534 can compute a filtered difference between the baseline and the candidate.

In some embodiments, the test engine 534 determines whether an anomaly exists in the candidate instance based on at least one of: identifying any logical error; detecting any performance degradation; monitoring any deviation in a call pattern of downstream dependencies; identifying any change in contracts with downstream or upstream services; or scrutinizing any logging pattern discrepancy between the at least one baseline instance and the candidate instance.

In some embodiments, in accordance with a determination that an anomaly exists in the candidate instance, the test engine 534 further determines whether the anomaly is temporary or persistent based on one or more retries of replaying the subset of traffic in the isolated environment against both the at least one baseline instance and the candidate instance. In some embodiments, in accordance with a determination that the anomaly is persistent, the test engine 534 further determines insight data indicating one or more factors causing the anomaly. Because a difference or anomaly in the responses could arise either due to new features or potential issues in the new change. As a result, the insight data regarding the anomaly provides crucial information for a user to carefully assess the risks and make informed decisions on whether to merge the pull request and proceed with the deployment to production. By empowering engineers with detailed valuable insights, the isolated test environment executor 430 ensures that users can confidently and wisely make decisions before deploying changes, with greater assurance, significantly improving the reliability and efficiency of production deployments.

In some embodiments, the at least one machine learning model utilized by the isolated test environment executor 430 (e.g. in the machine learning based transformer 533 and/or the test engine 534) includes a reinforcement learning (RL) model running in the isolated environment. In some examples, a system state of the RL model represents a snapshot of the production environment, incorporating data from multiple sources. The multiple sources may include: payload anomalies representing unusual changes or patterns in data payloads; log analytics indicating deviations or errors logged during operations; performance metrics indicating shifts in system performance indicators; contract and call patterns indicating irregularities in API contracts and usage patterns; configuration indicating current system settings; unhandled/handled exceptions; thread profiling indicating thread performance issues such as resource starvation, utilization and deadlocks; and dependency mapping indicating interactions between system components.

Based on a current system state of the RL model, an agent of the RL model takes one or more of the following actions: modifying a speed of processing data streams to stabilize system throughput (i.e. playback speed adjustment), implementing or adjusting a retry logic for failed operations (i.e. retry mechanisms), sampling and replaying requests or transactions out of the whole production recorded traffic to exploit service behavioral anomalies in the application (i.e. replay of new requests). A reward for the agent is computed based on an improvement or degradation of the system state, e.g. a difference in anomaly severity from a last system state to the current system state, following an action taken by the agent. In some embodiments, this would incentivize actions that result in an increase of anomalies or system instability. The agent of the RL model can be continuously trained based on updated data to adjust its strategies within the isolated environment that mirrors the production environment, for safe exploration of different strategies.

In some embodiments, during an evaluation: the RL agent is deployed within the isolated environment, where it operates in real-time, continually learning from new data and adjusting its strategies accordingly during the evaluation cycle. Unlike static anomaly detection systems, this RL framework adapts dynamically to changes in the system environment and evolving types of anomalies. In addition, the system learns from a broad array of data inputs, making it ideal to exploit a variety of anomalous conditions. By automating responses to anomalies, the system reduces the need for human intervention and can operate continuously to maintain system health.

Referring back to FIG. 4, the isolated test environment executor 430 can generate a report for the proposed change based on the analysis, where the report includes: the anomaly, the insight data, and a summary of the analysis. The isolated test environment executor 430 may transmit the report as a feedback 407 to the user device 404. In some embodiments, the feedback 407 may include a link to the detailed report.

In some embodiments, the user device 404 sends a deployment request 408 to the isolated test environment executor 430, after the user 402 approves the proposed change based on the feedback 407. In some embodiments, the isolated test environment executor 430 itself can automatically determine whether the proposed change is approved to be deployed into the application 440 based on the feedback 407.

In accordance with a determination that the proposed change is approved to be deployed into the application 440, the isolated test environment executor 430 can re-perform the analysis, using the at least one machine learning model, on the at least one baseline instance and the candidate instance during a deployment flow involving the proposed change and at least one additional approved change, before deploying the proposed change and the at least one additional approved change into the application 440.

In a typical scenario, pull requests may wait for extended periods, sometimes hours or even days, for peer code reviews. During this time, the isolated test environment executor 430 can diligently analyze the changes during off-peak hours, providing valuable feedback to the engineers. In some embodiments, the isolated test environment executor 430 can queue pull requests and analyze one pull request at a time during off-peak hours. The isolated test environment executor 430 may analyze the release version during deployment time before deploying it to production.

In some embodiments, multiple engineers might be working on different pull requests, and the deployment to production could involve merging several of these pull requests. During the deployment flow, the isolated test environment executor 430 once again performs the analysis, just before the actual deployment. The analysis remains the same as before, except that the candidate instance now runs the new application version from the deployment flow's release artifact.

In some embodiments, the system provides a customized feature extraction process to convert raw system metrics (e.g., response times, system throughput, error rates) into a format usable by RL models. The system addresses these challenges through a novel machine learning-based feature engineering technique designed to extract meaningful health signals from raw data generated by production systems. The system utilizes advanced algorithms to transform high-dimensional, noisy, and unstructured raw data into a structured format that highlights critical health indicators of the system. This process not only improves the accuracy of health assessments but also enhances the responsiveness of monitoring systems to emerging issues.

As shown in FIG. 4, the isolated test environment executor 430 may collect raw data from a plurality of sources associated with the application, e.g. other traffic sources 425, in addition to the production traffic 410. In some examples, the other traffic sources 425 may include: traffic profiles like holiday traffic, peak of peak; machine learning based traffic generator; an integration test suit; etc. In some examples, the isolated test environment executor 430 may further collect the raw data from: server logs, application logs, network traffic data, error messages, and system usage statistics. The raw data is often voluminous and contains a mixture of numerical values, text, timestamps, and binary data, reflecting the multifaceted nature of production environments.

In some embodiments, the isolated test environment executor 430 performs some initial preprocessing steps to clean and normalize the raw data. The initial preprocessing steps may include: timestamp synchronization to align data from different sources; null value handling to address gaps in data collection; and text normalization for log entries and error messages, including tokenization and removal of irrelevant substrings. From the normalized raw data, the isolated test environment executor 430 can use a first machine learning model to identify and construct features that are most indicative of the health of the system or the application. This step can be realized based on the following techniques: dimensionality reduction techniques, such as principal component analysis (PCA) or autoencoders, to reduce the number of data dimensions while retaining critical information; cluster analysis to group similar data points, highlighting common patterns or anomalies; time series analysis to capture temporal patterns and trends that signify normal or abnormal system behavior; and anomaly detection algorithms to identify outliers that could indicate potential issues. In some embodiments, each constructed feature is designed to represent a specific aspect of system health of the application, such as load capacity, error rates, response times, or unusual activity patterns.

In some embodiments, the isolated test environment executor 430 ranks the features using a second machine learning model (e.g. a random forest or gradient boosting model) based on their predictive importance scores regarding application health; and selects a subset of features having highest predictive importance scores. This step ensures that only the most relevant features are used for health signal extraction, optimizing both the performance and accuracy of the test and monitoring system.

The selected subset of features can then be used to construct a comprehensive health signal of the production system per service in the application. This health signal may be generated through a supervised machine learning model trained based on historical data, where system states have been labeled as healthy or unhealthy based on expert input. The isolated test environment executor 430 may thus monitor a health of the application 440 based on the health signals.

In some embodiments, the isolated test environment executor 430 employs a sophisticated array of circuit breaker rules to monitor not only the target application but also the leaf nodes of its dependency chain. The isolated test environment executor 430 provides a comprehensive view of the application's downstream dependencies 450, e.g. databases 452, cache 454 and downstream services 456. This in-depth monitoring ensures that any anomalies or issues are promptly detected, allowing for quick and informed decision-making during testing and production deployment, rather than spreading into downstream components.

As such, the system provides a sophisticated, adaptable framework for monitoring the health of production systems more accurately and responsively than traditional methods. By leveraging machine learning for feature engineering, the system allows for real-time, dynamic assessments of system health, facilitating early detection of issues and supporting proactive maintenance strategies.

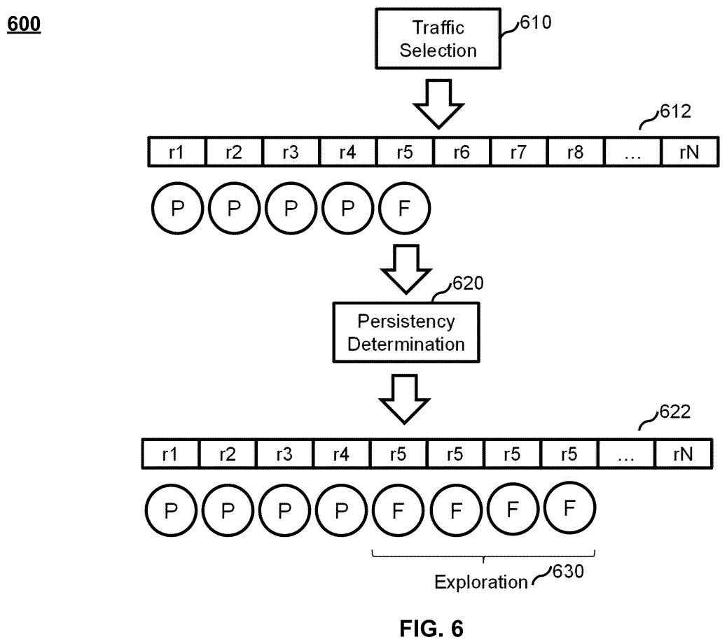

FIG. 6 illustrates an exemplary process 600 for traffic selection and anomaly persistency determination during application testing, in accordance with some embodiments of the present teaching. In some embodiments, the process 600 can be carried out by one or more computing devices, such as the application test computing device 102, and/or the cloud-based engine 121 of FIG. 1.

As shown in FIG. 6, the process 600 begins from operation 610, where the system selects traffic for testing the proposed change. As discussed above, by sampling the call requests subject to a minimum number of request samples per request type or endpoint, the sampled requests 612 have a higher percentage of outliers or anomalies than unsampled raw traffic.

In this example, the sampled requests 612 includes N samples or N requests, where N can be any integer number. During the testing process as discussed above regarding FIG. 5, each of the sampled requests 612 may be sent to the baseline service executor 535 and the candidate service executor 536 to determine whether there is any anomaly for the sampled request. A sampled request passes the test if the system does not detect any anomaly in payload, performance, contract, etc. during execution of the candidate version, i.e. during replaying of the sampled request to the candidate version, compared to the baseline version.

In the example shown in FIG. 6, each of the first four sampled requests r1˜r4 passes, while the fifth sampled request r5 fails, because an anomaly is detected when r5 is sent to the candidate version. Then at operation 620, the system determines whether the anomaly detected for r5 is temporary or persistent. In some embodiments, the system utilizes a machine learning model to determine whether the anomaly is persistent. By rerunning r5, at the operation 630 of exploration, based on any new features coming in, the system can determine whether this is a one-time issue or a real issue that is persistent.

As shown in the request list 622 during the exploration, instead of running r6˜r8, r5 is run four times in a row. In this example, the sampled requests r6˜r8 will be skipped and r9 will be run, if r5 is determined to be persistent (or temporary) after running four times. As such, the machine learning model is trained and used to minimize the repeating times needed to conclude whether an anomaly is persistent or not. For reinforcement learning, the reward would be much higher for finding an anomaly in a request compared to just replaying regular traffic request. In the example shown in FIG. 6, r5 fails all four times during the exploration 630, and is determined to have a persistent anomaly.

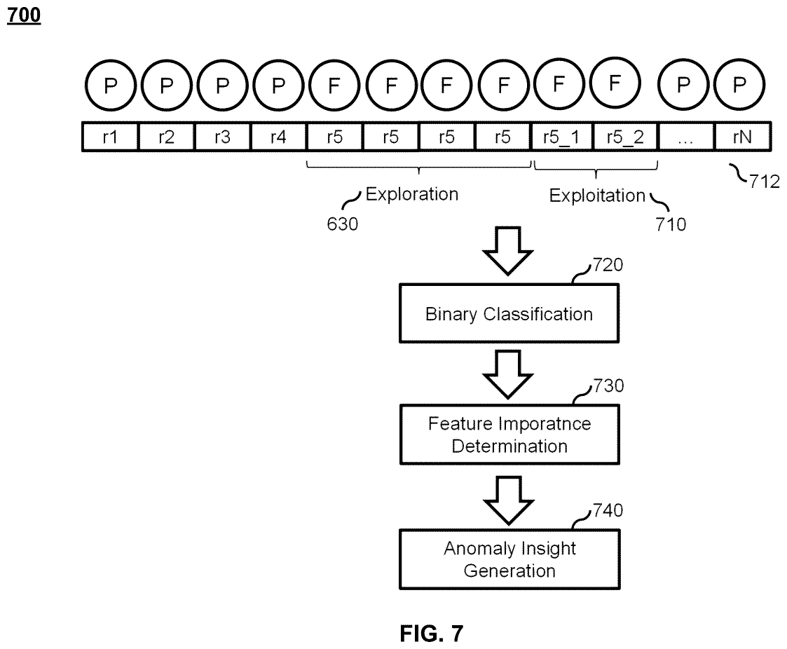

FIG. 7 illustrates an exemplary process 700 for exploitation and anomaly insight generation during application testing, in accordance with some embodiments of the present teaching. In some embodiments, the process 700 can be carried out by one or more computing devices, such as the application test computing device 102, and/or the cloud-based engine 121 of FIG. 1.

As shown in FIG. 7, the process 700 begins from operation 710 of exploitation, which may happen after the exploration 630 performed in the process 600 in FIG. 6. In some embodiments, after determining a sampled traffic request, e.g. r5, has a persistent anomaly, the system goes into an exploitation phase to look within the nearest neighbors of r5 within the original whole sample set, i.e. the original distribution of call requests in the endpoint (or session or request type) including r5. The system can quickly cherry pick more samples or neighbors that are similar to r5, and then run these neighbor requests of r5 (e.g. r5_1, r5_2) against the candidate version (as well as the baseline version) during the exploitation operation 710.

The purpose of the exploitation operation 710 is to determine what kind of features are common in the failed requests to conclude what are causing that anomaly. Running neighbor requests of r5 can help looking for new features to generalize and figure out the root causes of the concerned anomaly.

After testing all requests in the list 712, including the exploration 630 and the exploitation 710, each traffic request is labeled as pass (P) or fail (F) with relevant features. As such, the system can obtain a labeled data set including two different classes, a class that passed through and another class that failed.

At operation 720, a binary classifier may be built to classify the sampled requests and their corresponding features into the binary classes, pass or fail. Then at operation 730, the system can determine feature importance for each feature, e.g. which features contribute the most, in order to distinguish between these two classes. At operation 740, the system can generate anomaly insight data, e.g. text that reveal and explain to the user what the issues are and what are causing the issues.

In some embodiments, a disclosed system provides a pioneering approach for testing changes in the production environment without any customer impact. By adopting a “shift left” methodology, it brings the evaluation of new changes closer to the development phase, providing advanced insights to engineers at the earliest stages of development. This approach is designed to enhance software reliability and instill confidence in developing new features and deploying changes to production.

In some embodiments, the system utilizes a traffic replay feature, which has a novel ability to accurately replicate traffic patterns down to the millisecond-level granularity. This precision ensures that the testing environment closely mimics actual production scenarios, enhancing the accuracy of evaluations.

In some embodiments, the system determines the capacity of an application after implementing new changes, by incrementally replaying mirrored production traffic and strategically identifying the optimal point to evaluate throughput and latency. This approach provides engineers with critical insights into how code and configuration changes impact an application's performance in real-world scenarios, ensuring that new versions meet the required capacity standards.

In some embodiments, the system utilizes an intelligent schema change detection mechanism that operates by inferring schemas at runtime from mirrored production traffic requests and responses. This applies to many architectural patterns, by inferencing schema at runtime from the actual requests and responses exchanged between the baseline and candidate versions during traffic mirroring and replay. The system can adapt to schema changes without requiring predefined or static schemas, making it highly adaptable to evolving services. The schema inferencing process goes beyond simple payload validation by identifying complex data structures, including Enums, types, numerical ranges, and discriminated unions, providing a detailed and granular understanding of the data models used in services. The system automatically compares the inferred schemas between the baseline and candidate instances, detecting any differences or inconsistencies. This automated schema change detection simplifies the process of identifying potential issues introduced by code or configuration changes.

In some embodiments, the system thoroughly examines protocol headers and sidecar traffic, enabling a thorough monitoring and comprehension of communication patterns between the target application and its dependencies. By dynamically comparing the call patterns of baseline and candidate instances in real-time, the system offers an immediate evaluation of how modifications in the application's code or configuration impact its interactions with downstream services. This proactive analysis serves as an early warning system for identifying potential issues or deviations that require attention.

In some embodiments, the system incorporates intelligent noise filtering by performing a three-way comparison between two baseline instances and a candidate version. This comparison includes responses generated by both the baseline instances and the candidate version. Additionally, the system leverages machine learning techniques to learn from human feedback about noise in responses by gathering feedback from multiple human engagements with the analysis results and utilizing this feedback to retrain and refine its noise-detection model. This iterative feedback loop ensures that the system continuously improves its ability to identify and filter out noise in responses, resulting in more accurate and reliable assessments.

In some embodiments, the system fully embraces the shift left approach by enabling engineers to test changes directly from their integrated development environments (IDEs) in the production environment. This seamless integration empowers engineers with rapid feedback and allows them to assess the impact of their code modifications early in the development lifecycle.

In some embodiments, the system is agnostic to software language and service platform, such that the system works the same as an application is migrating from one platform to another, from one language to another.

In some embodiments, when a team of multiple developers or engineers are working together on the same application, the system provides a control plane to schedule all of different pull requests and evaluations one after another. In some examples, the control plane includes the following steps or phases in its execution flow: scheduler, evaluation, assessment, and reinforcement learning. At scheduler step, the system monitors all of the pull requests and releases. An evaluation can be scheduled at off-peak hours, to make sure that resources such as databases are not in contention. The off-peak hours may be determined based on geo-region, market type, service market cap, etc. The scheduling may be performed with SKU optimization and pod profiling.

After the scheduler has decided to schedule an evaluation for a pull request or for skipped immunization or for pod profiling, the system goes into the evaluation state, which executes the testing process as discussed above. The system can create all of the components, like the isolated environment, the traffic fixing, the engine, the reinforcement learning model, etc., to make sure they communicate with one another, and bring the isolation barriers. The system then executes the testing process following traffic replay procedure with the isolation barriers, to make sure the testing has no impact to end users. After the testing process is done, the system can record all of the anomalies and all of the observations from that execution, and delete the entire isolated environment to save cost.

Then the system goes into the assessment phase, where the system can gather all of the results and perform an analysis on the testing results. The system can publish the results and analysis summary (including anomaly list, insight data, etc.) for the pull request into a user interface, e.g. in the control plane, for an engineer to review and make decisions. The reinforcing learning component may be used to optimize or generalize some of the insights coming from the assessment. In some embodiments, the system also provides a detail API page to show: performance degradation results, status per API path, and evaluation results for multiple services.

The disclosed systems and methods represent a significant advancement in the use of artificial intelligence for automated testing, particularly in complex production environments where reliability and efficiency are critical. By leveraging reinforcement learning, the system not only reacts to current conditions but also continuously improves its response strategies based on ongoing feedback and learning. The disclosed testing framework provides a scalable, efficient, and risk-free solution to ensure the continuous reliability of production systems. By leveraging customized reinforcement learning techniques, it adapts to diverse and evolving environments, making it a robust tool for a broad range of applications across various industries. The disclosed method offers tailored, proactive testing strategies that significantly reduce downtime and enhance system performance.

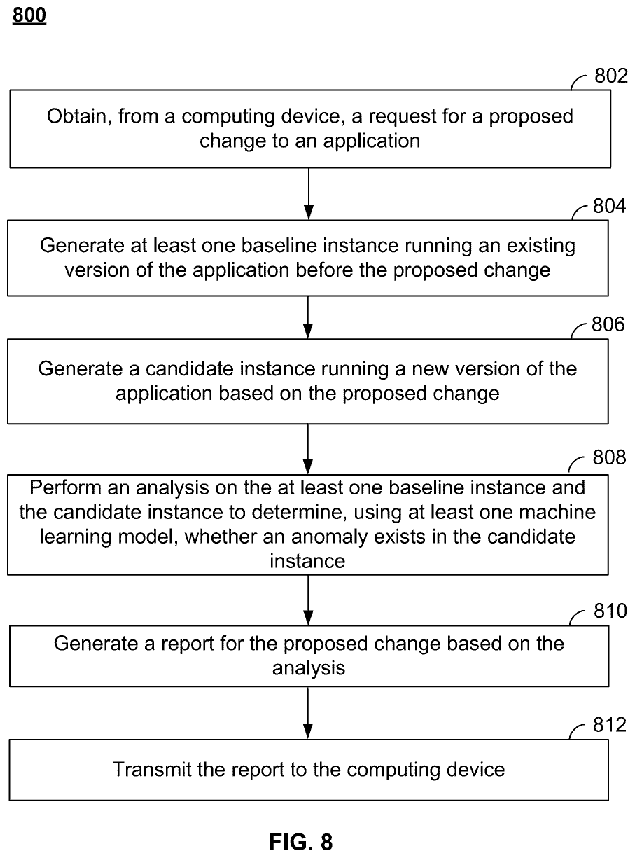

FIG. 8 shows a flowchart illustrating an exemplary method 800 for automatically testing changes to a software application using machine learning, in accordance with some embodiments of the present teaching. In some embodiments, the method 800 can be carried out by one or more computing devices, such as the application test computing device 102 and/or the cloud-based engine 121 of FIG. 1. Beginning at operation 802, a request for a proposed change to an application is obtained from a computing device. At operation 804, at least one baseline instance is generated to run an existing version of the application before the proposed change. At operation 806, a candidate instance is generated to run a new version of the application based on the proposed change. At operation 808, an analysis is performed on the at least one baseline instance and the candidate instance to determine, using at least one machine learning model, whether an anomaly exists in the candidate instance. A report is generated, at operation 810, for the proposed change based on the analysis, and is transmitted at operation 812 to the computing device.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMS, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory having instructions stored thereon; and
at least one processor operatively coupled to the non-transitory memory, and configured to read the instructions to:
obtain, from a computing device, a request for a proposed change to an application,
generate at least one baseline instance running an existing version of the application before the proposed change,
generate a candidate instance running a new version of the application based on the proposed change,
perform an analysis on the at least one baseline instance and the candidate instance to determine, using at least one machine learning model, whether an anomaly exists in the candidate instance,
generate a report for the proposed change based on the analysis, and
transmit the report to the computing device.

2. The system of claim 1, wherein:
the application is at least one of: a software application associated with an individual or an entity, a software application running on a data service platform, or a software application running on an online platform; and
the request is triggered by at least one of: a pull request initiated by an engineer working on the application, or a detection of the proposed change by monitoring the application.

3. The system of claim 1, wherein the at least one processor is configured to:
create an isolated environment for the application that is running in a production environment, by identifying and isolating traffic flows that are capable of impacting users of the application,
wherein the analysis is performed by executing the at least one baseline instance and the candidate instance in the isolated environment.

4. The system of claim 3, wherein the analysis is performed based on:
analyzing production traffic in the production environment;
generating mirrored traffic in the isolated environment based on the production traffic in the production environment;
selecting a subset of traffic from the mirrored traffic;
replaying the subset of traffic in the isolated environment against both the at least one baseline instance and the candidate instance; and
determining whether an anomaly exists in the candidate instance based on the replaying.

5. The system of claim 4, wherein determining whether an anomaly exists in the candidate instance comprises at least one of:
identifying any logical error;
detecting any performance degradation;
monitoring any deviation in a call pattern of downstream dependencies;
identifying any change in contracts with downstream or upstream services; or
scrutinizing any logging pattern discrepancy between the at least one baseline instance and the candidate instance.

6. The system of claim 4, wherein selecting the subset of traffic comprises:
determining a plurality of sessions in the mirrored traffic, wherein:
each session includes a sequence of requests, each of which calls to a functional endpoint of the application,
the requests in the plurality of sessions belong to a plurality of request types; and
sampling the requests in the plurality of sessions to select the subset of traffic subject to a minimum number of request samples per request type.

7. The system of claim 6, wherein determining whether an anomaly exists comprises:
sending a same set of sampled requests to the at least one baseline instance and the candidate instance;
receiving responses from the at least one baseline instance and the candidate instance;
comparing the responses from the at least one baseline instance and the candidate instance to determine at least one difference in the responses; and
determining whether the at least one difference represents an anomaly due to the proposed change.

8. The system of claim 6, wherein:
the at least one baseline instance comprises two baseline instances; and
determining whether an anomaly exists comprises:
sending a same set of sampled requests to the two baseline instances and the candidate instance;
receiving responses from the two baseline instances and the candidate instance;
comparing the responses from the two baseline instances to identify noise;
filtering out the noise from all responses of the two baseline instances and the candidate instance to generate filtered responses;
comparing the filtered responses of the two baseline instances and the candidate instance to determine at least one difference in the filtered responses; and
determining whether the at least one difference represents an anomaly due to the proposed change.

9. The system of claim 4, wherein the at least one processor is configured to:
in accordance with a determination that an anomaly exists in the candidate instance, determine whether the anomaly is temporary or persistent based on one or more retries of replaying the subset of traffic in the isolated environment against both the at least one baseline instance and the candidate instance.

10. The system of claim 9, wherein the at least one processor is further configured to:
in accordance with a determination that the anomaly is persistent, determine insight data indicating one or more factors causing the anomaly, wherein the report includes: the anomaly, the insight data, and a summary of the analysis.

11. The system of claim 3, wherein:
the at least one machine learning model includes a reinforcement learning (RL) model running in the isolated environment;
a system state of the RL model represents a snapshot of the production environment, incorporating data from multiple sources;
based on a current system state of the RL model, an agent of the RL model takes one or more of the following actions:
modifying a speed of processing data streams to stabilize system throughput,
implementing or adjusting a retry logic for failed operations,
sampling and replaying requests to exploit service behavioral anomalies in the application;
a reward for the agent is computed based on a difference in anomaly severity from a last system state to the current system state following an action taken by the agent;
the agent of the RL model is continuously trained based on updated data to adjust its strategies within the isolated environment that mirrors the production environment.

12. The system of claim 1, wherein the at least one processor is configured to:
collect raw data from a plurality of sources associated with the application;
process the raw data based on timestamp synchronization, null value handling and text normalization, to generate normalized raw data;
identify and construct features from the normalized raw data based on dimensionality reduction, cluster analysis, time series analysis, and anomaly detection, using a first machine learning model;
rank the features using a second machine learning model based on their predictive importance scores regarding application health;
select a subset of features having highest predictive importance scores;
construct health signals each corresponding to a service in the application using a third machine learning model based on the subset of features, wherein the third machine learning model is a supervised learning model trained based on historical data with application states labeled as healthy or unhealthy; and
monitor a health of the application based on the health signals.

13. The system of claim 1, wherein the at least one processor is configured to:
in accordance with a determination that the proposed change is approved to be deployed into the application, re-perform the analysis, using the at least one machine learning model, on the at least one baseline instance and the candidate instance during a deployment flow involving the proposed change and at least one additional approved change, before deploying the proposed change and the at least one additional approved change into the application.

14. A computer-implemented method, comprising:
obtaining, from a computing device, a request for a proposed change to an application;
generating at least one baseline instance running an existing version of the application before the proposed change;
generating a candidate instance running a new version of the application based on the proposed change;
performing an analysis on the at least one baseline instance and the candidate instance to determine, using at least one machine learning model, whether an anomaly exists in the candidate instance;
generating a report for the proposed change based on the analysis; and
transmitting the report to the computing device.

15. The computer-implemented method of claim 14, further comprising:
creating an isolated environment for the application that is running in a production environment, by identifying and isolating traffic flows that are capable of impacting users of the application,
wherein the analysis is performed by executing the at least one baseline instance and the candidate instance in the isolated environment.

16. The computer-implemented method of claim 15, wherein performing the analysis comprises:
analyzing production traffic in the production environment;
generating mirrored traffic in the isolated environment based on the production traffic in the production environment;
selecting a subset of traffic from the mirrored traffic;
replaying the subset of traffic in the isolated environment against both the at least one baseline instance and the candidate instance; and
determining whether an anomaly exists in the candidate instance based on the replaying.

17. The computer-implemented method of claim 16, wherein selecting the subset of traffic comprises:
determining a plurality of sessions in the mirrored traffic, wherein:
each session includes a sequence of requests, each of which calls to a functional endpoint of the application,
the requests in the plurality of sessions belong to a plurality of request types; and
sampling the requests in the plurality of sessions to select the subset of traffic subject to a minimum number of request samples per request type.

18. The computer-implemented method of claim 17, wherein determining whether an anomaly exists comprises:
sending a same set of sampled requests to the at least one baseline instance and the candidate instance;
receiving responses from the at least one baseline instance and the candidate instance;
comparing the responses from the at least one baseline instance and the candidate instance to determine at least one difference in the responses; and
determining whether the at least one difference represents an anomaly due to the proposed change.

19. The computer-implemented method of claim 17, wherein:
the at least one baseline instance comprises two baseline instances; and
determining whether an anomaly exists comprises:
sending a same set of sampled requests to the two baseline instances and the candidate instance,
receiving responses from the two baseline instances and the candidate instance,
comparing the responses from the two baseline instances to identify noise,
filtering out the noise from all responses of the two baseline instances and the candidate instance to generate filtered responses,
comparing the filtered responses of the two baseline instances and the candidate instance to determine at least one difference in the filtered responses, and
determining whether the at least one difference represents an anomaly due to the proposed change.

20. A non-transitory computer readable medium having instructions stored thereon, wherein the instructions, when executed by at least one processor, cause at least one device to perform operations comprising:
obtaining, from a computing device, a request for a proposed change to an application;
generating at least one baseline instance running an existing version of the application before the proposed change;
generating a candidate instance running a new version of the application based on the proposed change;
performing an analysis on the at least one baseline instance and the candidate instance to determine, using at least one machine learning model, whether an anomaly exists in the candidate instance;
generating a report for the proposed change based on the analysis; and
transmitting the report to the computing device.
